(19) United States
(12) Patent Application Publication
(10) Pub. No.: US 2008/0159273 A1
(43) Pub. Date: Jul. 3, 2008

(54) Method and apparatus for facilitating migration from an analog network to a voice over internet protocol network

(76) Inventor: David L. Brugman, San Clemente, CA (US)

Correspondence Address: FAY SHARPE/LUCENT, 1100 SUPERIOR AVE, SEVENTH FLOOR, CLEVELAND, OH, 44114, US

(21) Appl. No.: 11/648,465

(22) Filed: Dec. 29, 2006

(51) Int. Cl. H04L 12/66

(52) U.S. Cl. 370/356

(57) ABSTRACT

This invention relates to a method and system to migrate users from analog phone lines to VoIP connections on a per line basis. The method and apparatus mechanizes the multi-element network changes required for real time per line migration. All of the network elements are accessible from a single device. Each line can be migrated at the end user convenience by placing a telephone call to a server. In effect, this migration is actually moving a working line from one switch to another, in real time, without service interruption. Support databases may also be updated concurrently.

### BACKGROUND

This invention relates to a method and apparatus that controls per line migration of analog lines on a Public Switched Telephone Network (PSTN) to Voice Over Internet Protocol (VoIP) networks. Specifically, the required changes for this action are implemented in all network elements concurrently. Each migration is requested via a telephone call placed by an end user to a migration broker device. Communication with the end user is maintained through a voice interactive response session. The user replies to these voice requests using, for example, a touch-tone keypad on a telephone. The migration broker has connectivity to and communication with all analog network and VoIP network elements involved in the migration. Optionally, the migration broker also has connectivity to any support system database that may require changes as the result of a line move. The broker is programmed to communicate with each network element in the native protocol of the element using native commands and responses. The broker also logs all activity and provides mechanized statistical reporting. The user also receives status messages through voice responses as critical steps in the process complete.

While the invention is particularly directed to the art of VoIP migration of phone lines, and will be thus described with specific reference thereto, it will be appreciated that the invention may have usefulness in other fields and applications. For example, the teachings herein may be used when migrating lines from any one platform to another platform.

By way of background, when converting large customers from PSTN to VoIP network connections, previously known methods do not allow low risk and low cost line-by-line user driven migrations. Although such migrations are possible by manually reprogramming each network element, the time for which the line under migration is out of service can become lengthy. Manual data extraction of current configuration information for each migration and porting that configuration to the required VoIP network elements is both difficult and risky. In this regard, all of the network elements are not assessable from a single device.

It is desired to have a system that mechanizes the entire process and generates statistical reports that allow administrators to monitor the conversion status of projects.

The present invention contemplates a new and improved technique that resolves the above-referenced difficulties and others.

### SUMMARY

A method and apparatus for facilitating migration from, for example, an analog network to a voice over internet protocol network are described.

In one aspect of the invention, the system comprises a first switching element corresponding to the first phone system type, a second switching element corresponding to the second phone system type, wherein the second switching element is an Internet Protocol (IP) switch, and a Voiceover-Internet-Protocol (VoIP) Migration Broker disposed between the first switching element and the second switching element, the VoIP Migration Broker having a voice connection operative to receive instructions from a user on line configuration changes, wherein the VoIP Migration Broker is operative to query at least one of the first switching element and the second switching element on line configuration information, receive the instructions on the line configuration changes, implement the line configuration changes on the line configuration information based on the instructions to obtain a modified line configuration and send the modified line configuration to the first and second switching elements.

In another aspect of the invention, the first switching element is an analog switch.

In another aspect of the invention, the analog switch is a Class 5 switch.

In another aspect of the invention, the VoIP Migration Broker is operative to query the at least one of the first switching element and the second switching element by requesting a dump of text on the line configuration.

In another aspect of the invention, the VoIP Migration Broker is operative to implement changes by running a Perl script on the text to replace values.

In another aspect of the invention, the VoIP Migration Broker is operative to send a failure message if a request to the interface is not valid.

In another aspect of the invention, the VoIP Migration Broker is operative to send a failure message if the changes are not successful.

In another aspect of the invention, the information on the line configuration comprises information on line features and port assignments.

In another aspect of the invention, the VoIP Migration Broker is operative to rollback migration of lines.

In another aspect of the invention, the first phone system type is analog.

In another aspect of the invention, the second phone system type is VoIP.

In another aspect of the invention, the system further comprises a PBX unit.

In another aspect of the invention, the method comprises receiving a request to migrate lines to the VoIP phone system type through a voice connection, validating the request, querying at least one of a first switching element corresponding to the first phone system type and a second switching element corresponding to the VoIP phone system type to obtain line configuration data, receiving a line configuration data, modifying the line configuration data, and, sending a modified line configuration to the first and second switching element.

In another aspect of the invention, the method further comprises sending a failure message if validating is not successful.

In another aspect of the invention, the method further comprises sending a failure message if the modifying is not successful.

In another aspect of the invention, the method further comprises sending a failure message if the confirming is not successful.

In another aspect of the invention, the method further comprises providing a software rollback of lines.

In another aspect of the invention, the querying comprises requesting a dump of text to obtain text on the line configuration data.

In another aspect of the invention, the modifying comprises modifying values in the text.

In another aspect of the invention, the sending comprises sending the modified text having replaced values to the first and second switching elements.

In another aspect of the invention, the method further comprises modifying a line configuration in a PBX system.

In another aspect of the invention, the method further comprises sending a failure message if the modifying of the PBX system is not successful.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a call flow prior to an Analog to VoIP migration in a TDM telephone environment.

FIG. 2 is a block diagram illustrating a VoIP Migration Broker placement during an analog telephone line to VoIP line migration.

FIG. 3 is a block diagram illustrating a call flow before an Analog PBX to VoIP migration.

FIG. 4 is a block diagram illustrating a VoIP Migration Broker placement during an analog PBX line to VoIP line migration.

FIG. 5 is a block diagram illustrating a call flow prior to an IP PBX line to VoIP migration.

FIG. 6 is a block diagram illustrating a call flow after an Analog PBX to VoIP migration.

FIG. 7 is a block diagram illustrating two additional capabilities for the VoIP Migration Broker.

FIG. 8 is a flow chart illustrating a method according to the presently described embodiments.

FIG. 9 is a flow chart illustrating a method according to the presently described embodiments.

### DETAILED DESCRIPTION

The presently described embodiments correlate software tools that facilitate migration of lines between dissimilar programming platforms. This technique allows for brokering of the end user requests into the specific network element inputs and retrievals that are required to move the line from, for example, the PSTN to the VoIP network. In at least one form, all of the telecommunications provisioning capabilities, network assess capabilities and dial-tone port mapping tools are centralized on a migration broker device (e.g. referred to herein as a VoIP Migration Broker), taking the form of a personal computer (PC) in at least one embodiment. This centralized capability is accessible, in one form, by placing a telephone call to the VoIP Migration Broker from an end user or technician on the PSTN. When the call is answered, by the VoIP Migration Broker, the Broker automatically issues voice requests and responses that direct the person placing the call through the migration.

In this way, the presently described embodiments relate to a method and apparatus for activation and deactivation of the line translations in all switching elements allowing per line analog to VoIP telephony line service conversion. Optionally, as will be described hereinafter, concurrent action can be triggered to redirect voice mail and transmit information that can be used to synchronize support system databases.

In one form, this technique is implemented to mechanize the final steps in the overall line conversion process. It is assumed the IP Softswitch connected to the PSTN and TCP/IP Network will be fully functional. Fully functional in context means the IP Softswitch is ready to accept new subscribers, process all internal calls, process all feature delivery and deliver incoming and outgoing calls to the PSTN for those subscribers.

The benefits of the presently described embodiments include:

1. The customer can schedule the migration to coincide with the real time placement and programming of the VoIP telephone.

2. This method reduces conversion risk and installation skill requirements.

3. The line can be converted in real time at any time of the day. The only requirement is that the line must not be in use during the migration period.

4. The customer can request reverse migrations if required.

5. The process delivers electronic progress reports to the administrators.

6. Voice mailboxes and support system databases can be changed as part of the migration.

7. Security is enhanced because of the control and the limitations that can be placed on the migration request.

8. The migration can be accomplished in one interactive session, e.g., a voice response session.

The present invention can be embodied in several system configurations. In this regard, referring now to the drawings wherein the showings are for purposes of illustrating the exemplary embodiments only and not for purposes of limiting the claimed subject matter, FIG. 1 provides a view of a system 10 into which the presently described embodiments may be incorporated.

This system shown in FIG. 1 is an exemplary system having analog lines and VoIP lines. As shown, the configuration represents a system prior to installation of a VoIP Migration Broker in accord with the teachings of the presently described embodiments. Link 1 represents the dial tone connection to an analog phone 12 that is connected to a switch 14, e.g. an analog Class 5 switch, before migration begins. Link 2 represents the switch connection to the Public Switched Telephone Network (PSTN) 16. Link 3 illustrates a connection between a VoIP telephone 18 and a private TCP/IP network 20 that is associated with an IP Switch 22, also referred to as IP Switch and Media Gateway 22. Link 4 represents a connection between the private IP network 20 and the IP Switch 22. Link 5 represents the trunking connection that will carry calls to the PSTN 16 from provisioned VoIP lines.

The analog telephone 12 receives dial tone from the Class 5 switch 14 on link 1. The analog telephone 12 communicates with other lines that are provisioned on the analog, or Class 5, switch 14 through similar connections. When the analog line needs to communicate with other telephones in the PSTN 16, link 2 is used. Although the VoIP telephone 18 can be physically placed, the link 3 is not provisioned. After link 3 is provisioned, the VoIP telephone 18 will be able to communicate with other VoIP telephones on the TCP/IP network using links 3 and 4 and communicate with the PSTN 16 via link 5.

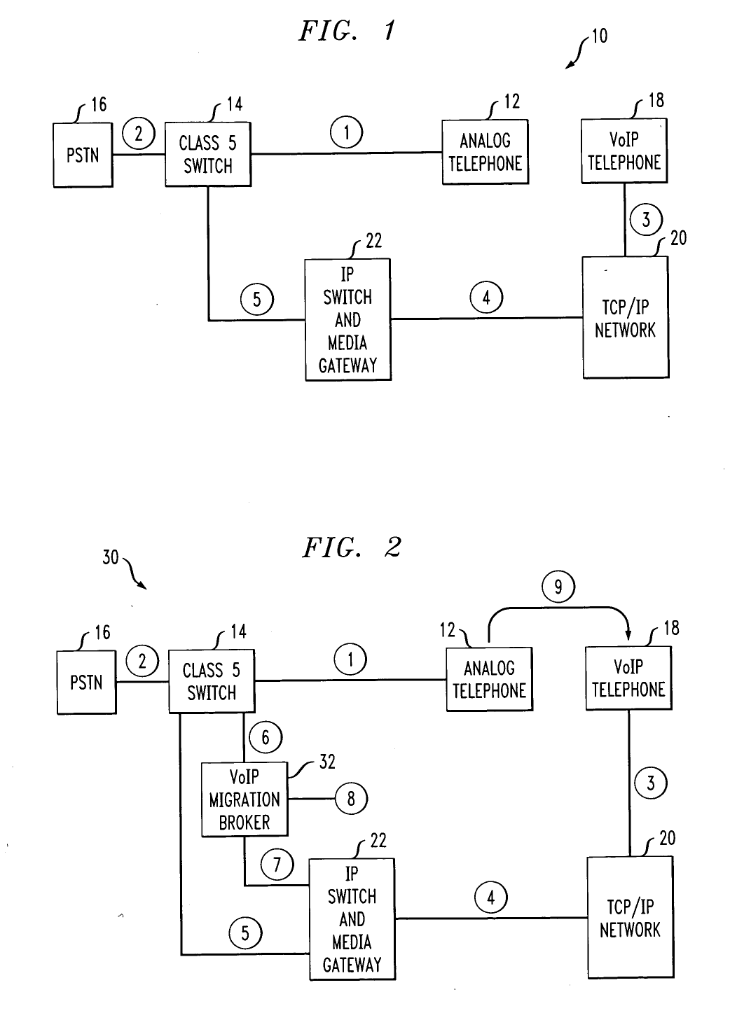

FIG. 2 outlines the linkage of the analog to VoIP migration process according to the presently described embodiments and FIG. 8, described hereafter, depicts a corresponding process flow. Like reference numerals in FIGS. 1 and 2 represent substantially the same elements. Moreover, the difference between the network 10 of FIG. 1 and a network 30 of FIG. 2 is the implementation of a VoIP Migration Server or Broker 32.

It should be appreciated that the VoIP Migration Broker 32 (as well as the VoIP Migration Brokers 52, 62 and 72 described hereafter) only needs to be active in the network during the customer defined transition period. It need not be a permanent network element. However, it should also be appreciated that the Broker 32 may take a variety of forms. It may be implemented using various software techniques and/or different hardware configurations. For example, the Broker 32 may be implemented as a software routine that primarily resides on one of the switching elements or distributed on the network. The Broker 32 is, in one form, also provided with a voice response unit to allow for convenient user interaction.

In one form, a serving computer is used as a VoIP Migration Server or Broker 32 and is placed on an internal network segment of a service provider that has access to the associated network element provisioning channels. The VoIP Migration Broker 32 is accessed for administrative purposes through standard web browser connectivity. However, a user attempting to migrate lines accesses the Broker 32 through dial-up connectivity and manipulates simple input requests using touch tone pad requests for desired changes. Of course, in one form, the voice response unit is used to implement this process. It should be appreciated that web browser connectivity could also be used to migrate lines; however, sufficient security measures would typically need to be employed.

In any event, all changes are first verified for validity and delivered to the proper network elements in the correct order. When the end user selects a telephone number and then requests a migration, the VoIP Migration Broker issues and monitors the network element software changes and provides real-time status updates.

The software tools on the VoIP Migration Broker may take a variety of forms, but in one form, include a Web server, an SQL database, programming languages to communicate with network elements using text interfaces, the TCP/IP communications utilities and custom Shell, Perl, AWK, PHP, SQL and Tool Control Language Expect scripts.

The Web server provides an administrative interface. An administrator typically uses the web interface to set-up, maintain and observe the system, for example.

Use of, and extremely restricted access to, the SQL database provides the connection security typical users require. It also maintains in a secure fashion all of the software messaging that will be delivered to the involved switches. It is also used to track all access and store delivery benchmarks. The database is also used to generate activity reports when the user requests them.

The software scripts mechanize access security, software change message generation, switch communications (such as analog (Class 5) and VoIP) for data collection and software change message delivery, SQL database administration and user report generation. Previously, this work was typically done using several provisioning support systems.

The capability the invention provides reduces the line migration period from several hours to about a minute. It also obviates the need for as many as 5 of the previously required 6 support system work orders.

Referring back now to FIG. 2, Link 1 represents the dial tone connection to the analog phone 12 that is connected to the analog switch 14 before migration begins. Link 2 represents the switch connection to the Public Switched Telephone Network (PSTN) 16. Link 3 represents the VoIP telephone connection to the private TCP/IP network 20 that is associated with the IP Switch 22. Link 4 represents the connection between the private IP network 20 and the IP Switch 22. Link 5 represents the trunking connection that will carry incoming and outgoing calls to the PSTN 16 for provisioned VoIP lines. Link 6 represents a provisioning connection between the VoIP Migration Broker 32 and the IP Switch 22. Link 7 represents a provisioning connection between the VoIP Migration Broker 32 and the IP Switch 22. Link 8 represents the dial tone connection on the broker 32 that receives the incoming migration request calls. Link 9 represents the subscriber's transition from use of the analog telephone 12 to use of the VoIP telephone 18.

In operation, the person administering the VoIP Migration Broker 32 establishes a work order list and port mapping information before migration can be initiated. The actual migration begins with a call to the VoIP Migration Broker 32 to initiate a voice response session wherein the Brokers issues voice requests that may be answered by the user using the keypad. The VoIP Migration Broker then requests a valid user logon and password from the user. The user inputs these requirements. The VoIP Migration Broker's database is consulted. If access is granted, the database on the VoIP Migration Broker is interrogated using a programming language such as a Perl script for exact analog, or Class 5, connection. The VoIP Migration Broker uses the internal database connection information to access the analog, or Class 5, switch through the intervening support systems, or it can connect to the switch directly it if there are no associated support systems. Once connection to the analog, or Class 5, switch has been established the connection is logged in the VoIP Migration Broker database using a shell driven Perl script. The Broker 32 issues a voice response requesting a work order number from the user (link 8).

The user inputs the work order number using, for example, a touchtone keypad of a phone (link 8). In at least one form, the work order number is required for security purposes and is used to insert port and feature information into the provisioning message that will be executed on the IP switch 22.

If the work order input by the user matches an item on the work list, a provisioning channel is accessed (link 6). The telephone number on the work list is interrogated on the Class 5 switch and the current features are stored. The VoIP Migration Broker checks the migration state on the line and if the state is pre-migration, the broker verifies the line software, computes the migration forward and rollback messaging, and sends the changes to the VoIP switch 22 using a native protocol. It should be appreciated that the computing of messaging regarding the changes involves a number of functions including the generation of provisioning orders. For example, the VoIP switch is queried by the VoIP Migration Broker to obtain a text dump of information on the features that are available on the line and the port assignments. A Perl script (prepared by the user using appropriate mapping information) is run on the text to replace features in the text, based on the mapping information. By modifying the text, the VoIP switch will be able to understand the changes when it receives them. So, once the changes are received by the VoIP switch, the line is evolved to its migrated state.

Provisioning orders for the IP Switch 22 are prepared in real time using the port mapping tools on the VoIP Migration Broker 32. Customer Originated Recent Changes (CORCs) are extracted from the switch 14 and provisioning orders to port information to the IP Switch 22 are also prepared. Then, the IP Switch is accessed (link 7) and the provisioning orders are delivered. In this regard, the line configuration changes are constructed based on current software equipage, switch port assignment, replacement telephone instrument type and the replacement feature functionality. The current line equipage is collected and analyzed as an integral part of the process. Scripts for this data collection are stored by switch type and are associated with the switch under migration in the internal VoIP Migration Broker database. Also, the feature mapping tools typically take the form of custom scripts based on the user's needs that are placed on the VoIP Migration Broker. The mapping requirements are documented in a text file and Perl and AWK scripts are constructed to build and store the software change messages required for migration and rollback. Appropriate software changes are then delivered to the switch 22 and monitored by the VoIP Migration Broker 32 over link 7 (as described above). These software changes include specific software messaging and the appropriate protocols to administer message specific provisioning channel conversations on a per change basis. As the changes are sent to the VoIP switch, all expected switch provisioning channel responses are accounted for and answered without user intervention. Link 9 represents the roll forward of the switch software. In this context, a roll forward includes line software feature removals and additions based on the previously described mapping requirements. The switch port providing dial tone is not changed.

Once the VoIP switch notifies the Broker 32 that the requested software changes have been completed, the activity is logged in the Broker database and the user is notified. This process from the user's point of view is complete. and is free to disconnect from the voice session.

A rollback provisioning order for the switch 14 is prepared and stored for future use in real time. Typically, a rollback provisioning order includes all software features that are associated with a specific line before any migration is requested. The rollback provisioning order is constructed in a way that allows changes to be applied to the line in the migrated state. A rollback order cannot be applied to a line unless it has been previously migrated. Current migration status is stored in the work list.

Briefly, as detailed above, a typical migration session includes many steps. At times, the user will already be engaged in a voice response session with the VoIP Migration Broker and a work error occurs in the field or the replacement telephone instrument is not functioning correctly. The user then types the telephone number to be rolled back using the keypad and requests a rollback. The work-list on the VoIP Migration Broker is checked and if the line requested has a status of migration complete in the internal database, it sends the changes (as above) to the analog, or Class 5, switch using its native protocol. Once the analog switch notifies the Broker that the requested software changes have been completed, the activity is logged in the Broker database and the user is notified.

If the operation of migrating is successful, the line is disconnected in the switch 14 (link 6) and then the telephone number is routed to the trunk group that passes PSTN traffic to subscribers on the IP Switch 22. At this point, the analog phone 12 will not have dial tone. All actions are automatically logged by the server as they occur for future use. A vocal success message is delivered to the calling party (link 8). At this point the person who requested the migration needs to verify operation of the VoIP telephone 18 and then physically remove (link 1) the analog telephone 12 if the VoIP telephone 18 is functioning properly. If the VoIP telephone does not function properly, a reverse migration can be requested by placing another call to the VoIP Migration Broker 32 (link 8). Again, the work order will be requested and the called will be asked if they need to have the procedure reversed (link 8). A touchtone code will be required to initiate this action. Since the roll back provisioning messages are available, they will be applied to the switch 14 (link 6) and the line will be disconnected in the IP Switch 22 (link 7). A completion announcement will be delivered to the user (link 8). Statistics will also be logged for each step in this process.

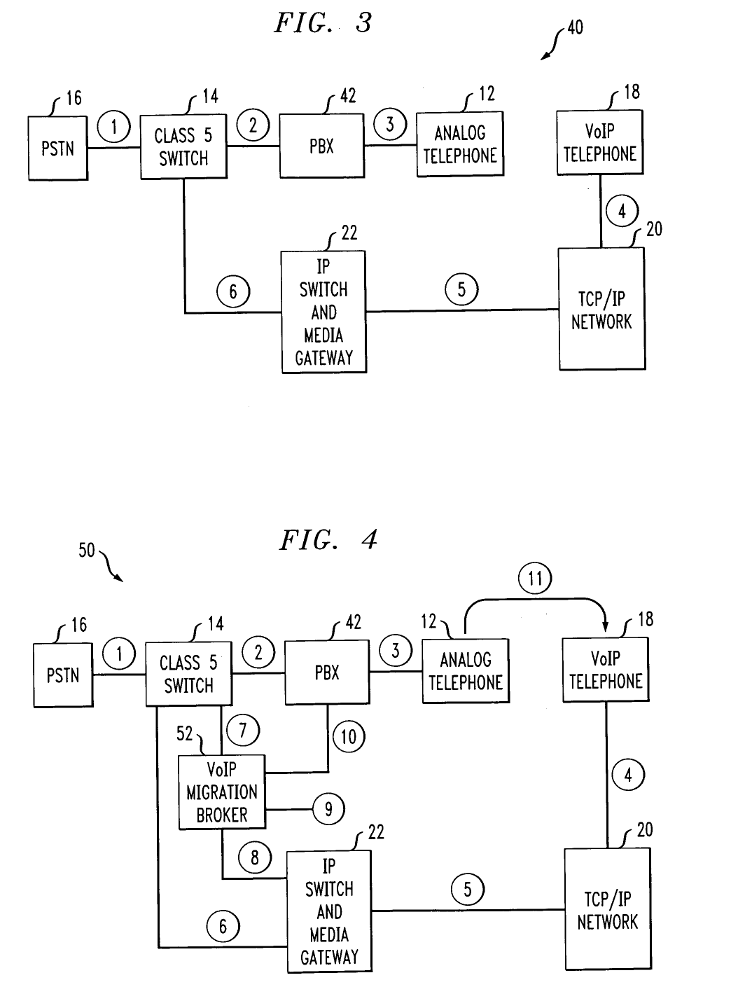

In another embodiment of this invention, Analog Public Branch Exchange (PBX) to VoIP migration is accomplished. By way of background, FIG. 3 illustrates a configuration of a system 40 that utilizes Analog PBX and VoIP lines but does not utilize a VoIP Migration Broker according to the presently described embodiments. Again, like reference numerals represent like components as compared to other configurations described herein.

In addition, Link 1 represents the switch connection to the Public Switched Telephone Network 16. Link 2 represents the connection of the PBX to the Class 5 switch 14 before migration begins. Link 3 represents the dial tone connection between the PBX 42 and the analog telephone 12. Link 4 represents the VoIP telephone connection to the private TCP/IP network 20 that is associated with the IP Switch 22. Link 5 represents the connection between the private IP network 20 and the IP Switch 22. Link 6 represents the trunking connection that will carry calls to the PSTN 16 from provisioned VoIP lines.

The analog telephone 12 receives dial tone from the PBX 42 on link 3. The analog telephone communicates with other lines that are provisioned on the PBX 42 using similar arrangements. The analog telephone 12 communicates with the PSTN over links 2 and 3.

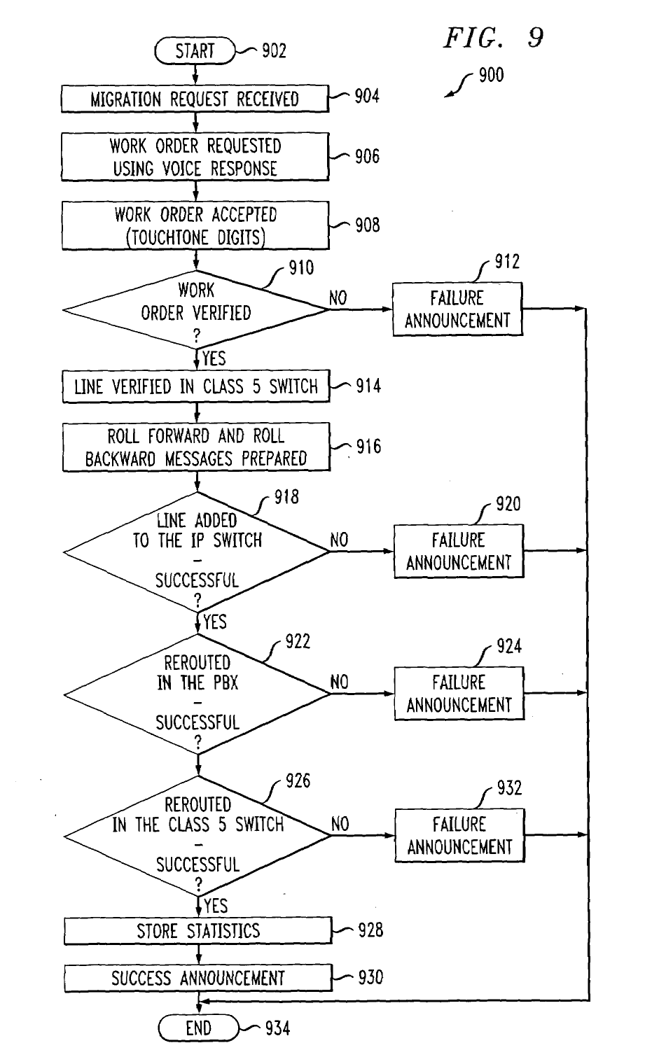

The configuration of the system of FIG. 3 with a VoIP Migration Broker 52 is placed is illustrated in FIG. 4, and is shown as a system 50. It should be appreciated that the VoIP Migration Broker 52 (as well as Brokers 62 and 72) is configured and operates in substantially the same manner as does VoIP Migration Broker 32. A corresponding process flow is outlined in FIG. 9, and will be described below.

The links referred to in the rest of this embodiment are links in FIG. 4. Again, like reference numerals represent like components as compared to other configurations described herein.

In addition, Link 1 represents the analog, or Class 5, switch connection to the Public Switched Telephone Network (PSTN) 16. Link 2 represents the connection of the PBX 42 to the Class 5 switch 14 before migration begins. Link 3 represents the dial tone connection between the PBX 42 and the analog telephone 12. Link 4 represents the VoIP telephone connection to the private TCP/IP network 20 that is associated with the IP Switch 22. Link 5 represents the connection between the private IP network 20 and the IP Switch 22. Link 6 represents the trunking connection that will carry calls to the PSTN 16 from provisioned VoIP lines. Link 7 represents a provisioning connection between the VoIP Migration Broker 52 and switch 14. Link 8 represents a provisioning connection between the VoIP Migration Broker 52 and the IP Switch 22. Link 9 represents the dial tone connection on the broker 52 that receives the incoming migration request calls. Link 10 represents a provisioning connection between the VoIP Migration Broker 52 and the PBX 42. Link 11 represents the subscriber's transition from use of the PBX telephone 12 to use of the VoIP telephone 18.

In operation, the system 50 (as well as systems 60 and 70) functions—for purposes of migration—in substantially the same way as the system 30 of FIG. 2 except that line information regarding the PBX element is also relevant to the migration process. Briefly, a person administering the VoIP Migration Broker 52 will need to establish a work order list and port mapping information on the server before migration can be initiated. In this embodiment, the port mapping tools will contain pre and post routing information for the routing telephone number on the Class 5 switch.

As detailed in FIG. 4, the actual migration begins with a call to the VoIP Migration Broker 52 (link 8). The call is answered by the broker 52 and, if appropriate, then it issues a voice response requesting a work order number from the user. The user inputs the work order number using, for example, a touchtone keypad. In this embodiment, the analog line being migrated is receiving dial tone from the PBX 42 (Link 3). In a manner similar to that described above in connection with the analog and VoIP switches, the feature information is extracted from the PBX 42 (link 9) and roll back provisioning orders for the PBX 42 are constructed in real time. In this regard, appropriate queries on line configurations and text modification of the information are accomplished using suitable scripts. The line is disconnected in the PBX 42 (link 10) and the telephone number is routed to the trunk group that connects the PBX 42 to the switch 14 (link 7). The line is provisioned on the IP Switch 22 (link 8) in manners as described above. The telephone number is rerouted on the analog, or Class 5, switch 14 (link 7) from the PBX trunk to the IP Switch trunk group. All activities are logged and a success message is issued to the user. The user can then test the VoIP telephone 18 for functionality and remove the analog phone 12. As in previous embodiments, the provisioning can be reversed by placing a call to the VoIP Migration Broker 52 (link 9).

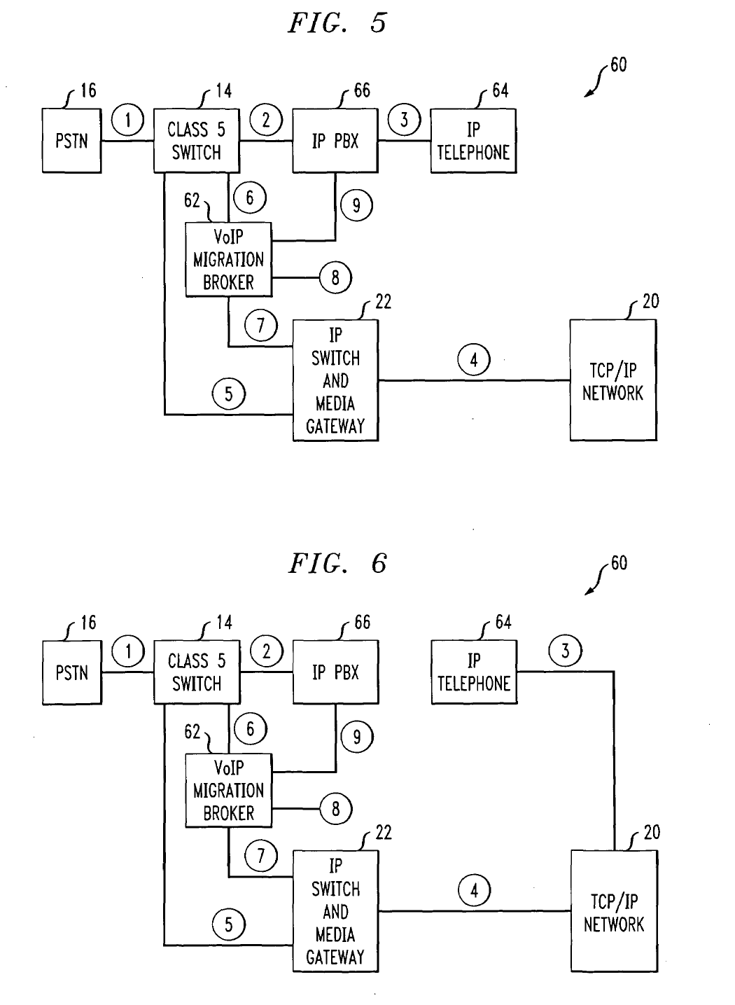

Another embodiment of this invention is implemented to accomplish an IP Call Manager to VoIP migration. In this embodiment, the work list contains all of the information needed to provision the line on the IP switch. In this regard, FIG. 5 is an overview of a call flow from the IP telephone 64 before migration.

Link 1 represents the Class 5 switch connection to the Public Switched Telephone Network 16. Link 2 represents the PSTN access trunking connection to the PBX 66 that is connected to the switch 14 before migration begins. Link 3 represents the IP based telephone connection to the IP PBX 66. Link 4 represents the connection between the private IP network 20 and the IP Switch 22. Link 5 represents the trunking connection that will carry calls to the PSTN from provisioned VoIP lines. Link 6 represents a provisioning connection between the VoIP Migration Broker 62 and the switch 14. Link 7 represents a provisioning connection between the VoIP Migration Broker 62 and the IP Switch 22. Link 8 represents the dial tone connection on the broker 62 that receives the incoming migration request calls. Link 9 represents a provisioning connection between the VoIP Migration Broker 62 and the IP PBX 66.

A difference in this embodiment is the reuse of the IP telephone 64. The IP telephone 64 is converted from SCCP (i.e., Skinny Client Control Protocol) signaling to SIP (i.e., Session Initiated Protocol) signaling at migration. Link 3 in FIG. 5 is removed and link 3 in FIG. 6 is established. The IP telephone is now connected to the TCP/IP network 20 that is associated with the IP switch 22. In this configuration, a call is placed to the VoIP Migration Broker 62 on link 8 as show in FIG. 6.

In operation, a work order number is requested and, if valid, the line is provisioned on the IP switch 22 using link 7, as described above. In this regard, as above, appropriate queries on line configurations and text modification of the information are accomplished. The line is then disconnected in the IP PBX 66 via link 9. PSTN 16 access the telephone number on the work list is rerouted from link to link 5 using link 6.

With reference to FIG. 6, Link 1 represents the Class 5 switch connection to the Public Switched Telephone Network 14. Link 2 represents the PSTN access trunking connection to the IP PBX 66 that is connected to the Class 5 switch 14 before migration begins. Link 3 represents the SIP (Session Initiated Protocol) based VoIP telephone connection to the private TCP/IP network 20 that is associated with the IP Switch 22. Link 4 represents the connection between the private IP network 20 and the IP Switch 22. Link 5 represents the trunking connection that will carry calls to the PSTN 16 from provisioned VoIP lines. Link 6 represents a provisioning connection between the VoIP Migration Broker 62 and the switch 14. Link 7 represents a provisioning connection between the VoIP Migration Broker 62 and the IP Switch 22. Link 9 represents a provisioning connection between the VoIP Migration Broker 62 and the PBX 66.

Another embodiment relates to the addition of voice mailbox migration and support system database synchronization. It should be understood that the migration, in one form, will be conducted in substantially the same manner as described above.

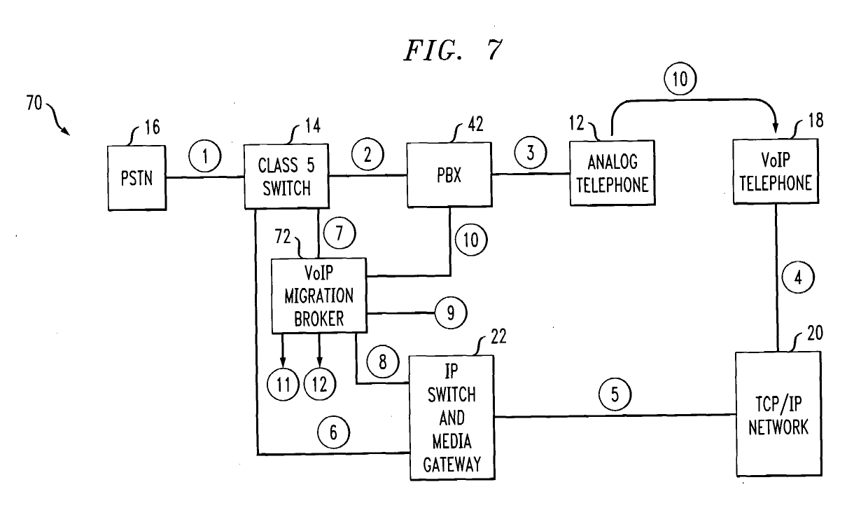

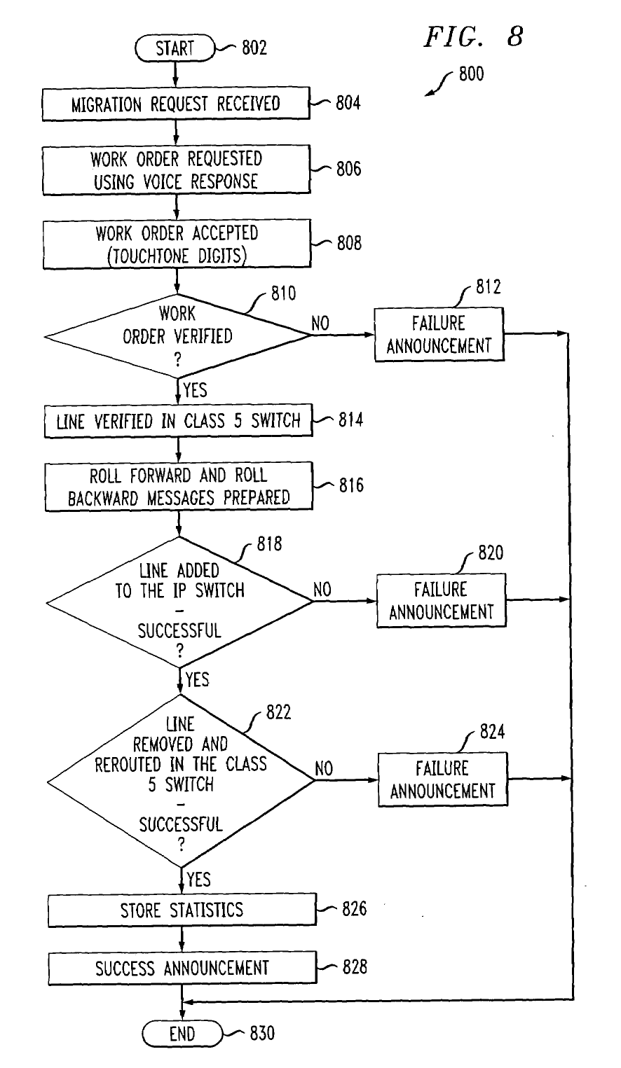

In FIG. 7, for example, a system 70 is shown. The system 70 allows for notification or updating of a voicemail system or support system database structure with respect to the migration of lines contemplated herein. A link 11 represents connection of a broker 72 to the device administering the voice mailbox database. Link 1 represents the Class 5 switch connection to the Public Switched Telephone Network 16. Link 2 represents the dial tone connection to the PBX 42 that is connected to the switch 14 before migration begins. Link 3 represents the dial tone connection between the PBX 42 and the analog telephone 12. Link 4 represents the VoIP telephone connection to the private TCP/IP network 20 that is associated with the IP Switch 22. Link 5 represents the connection between the private IP network 20 and the IP Switch 22. Link 6 represents the trunking connection that will carry calls to the PSTN 16 from provisioned VoIP lines. Link 7 represents a provisioning connection between the VoIP Migration Broker 72 and switch 14. Link 8 represents a provisioning connection between the VoIP Migration Broker 72 and the IP Switch 22. Link 9 represents the dial tone connection on the broker 72 that receives the incoming migration request calls. Link 10 represents a provisioning connection between the VoIP Migration Broker 72 and the PBX 42. Link 11 represents connection to the voice mailbox database migration capability. This connection can be established through either a physical IP port based connection or the database change information can be delivered through an electronic process such as email. This connection will vary according to customer need. Link 12 represents connection to support system database update mechanisms. This link can also be a physical IP port based connection or the database change information can be delivered through an electronic process such as email. As subscriber access is migrated from the analog connection to the VoIP connection, the appropriate synchronization message is passed to that device over this link.

To serve as further examples of implementation and for clarity, FIGS. 8 and 9 are flow charts illustrating methods according to the presently described embodiments. It should be appreciated that the methods according to the presently described embodiments may be implemented using a variety of suitable software techniques and hardware configurations. for example, as noted above, suitable software routines may be maintained on any of the network elements including the VoIP Migration Broker or the various switching elements, e.g., the Class 5 switch or the IP switch. Of course, the software may be distributed among various network elements.

FIG. 8 relates to the operation of the invention as shown, for example, in FIG. 2. The method 800 is illustrated and begins (at 802). The broker 32 is equipped with the ability to play voice messages to the party making the call and then accept and respond to requests it receives from the person making the call through touchtone digit commands. After answering the call (at 804), the broker issues a voice request to the user for a work order number to be input from the touchtone pad (at 806). Once the work order is received and accepted (at 808), the number is verified using a previously inserted list of expected requests (at 810). If the work order is invalid, the user is notified via a voice response and the call is terminated (at 812). If the work order is valid, the Class 5 switch is interrogated for the current status of the line to be migrated (at 814). Roll forward and roll back provisioning messages are prepared in real time (at 816). The information from the interrogation is combined with port mapping information housed on the broker and the line is provisioned in the IP switch under program control of the Broker (at 818). If this is not successful, a failure announcement is issued (at 820). If the process is successful, the line in the Class 5 switch is then disconnected and rerouted to the trunk group that connects the IP Switch and Media Gateway to the Class 5 switch for PSTN access for the new VoIP service (at 822). If the process is not successful, a failure announcement is transmitted (at 824). If the process is successful, statistics are recorded for future use (at 826). The analog telephone no longer has dial tone from the Class 5 switch and can now be removed. A success announcement may then be transmitted (at 828). The process then ends (at 830).

FIG. 9 represents the operation of the invention described, for example, in FIG. 4. The process of migration described may also be applied to the systems of FIGS. 5, 6 and 7. The work set-up process and end results are the same as described in connection with FIG. 8 but the provisioning methods are different. Again, a call is placed to the VoIP Migration Broker over the PSTN (at 902). After answering the call (at 904), the broker issues a voice request to the user for a work order number to be input from the touchtone pad (at 906). Once the work order is received and accepted (at 908), the number is verified using a previously inserted list of expected requests (at 910). If the work order is invalid, the user is notified via a voice response and the call is terminated (at 912). If the work order is valid, the analog, or Class 5, switch and PBX are interrogated in turn (at 914). Rollback messages are prepared for both the Class 5 and PBX (at 916). The information from the interrogation is combined with port mapping information housed on the broker and the line is provisioned in the IP switch under program control of the Broker (at 918). If the process fails, a failure announcement is transmitted (at 920). If the process is successful, the line is first disconnected in the PBX and rerouted to the trunk group that connects the PBX to the Class 5 switch (at 922). If the process fails, a failure announcement is transmitted (at 924). The telephone number is then rerouted in the Class 5 switch to the trunk group that connects the IP Switch and Media Gateway to the Class 5 switch for PSTN access (at 926). If successful, statistics are recorded for future use (at 928) and a success announcement is transmitted (at 930). The analog telephone no longer has dial tone from the PBX and can now be removed. If the process is unsuccessful, a failure announcement is transmitted (at 932). In any event, the method terminates at some point (at 934).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for migrating lines in a telephone network from a first phone system type to a second phone system type, the system comprising:
a first switching element corresponding to the first phone system type;
a second switching element corresponding to the second phone system type, wherein the second switching element is an Internet Protocol (IP) switch; and
a Voice-over-Internet-Protocol (VoIP) Migration Broker disposed between the first switching element and the second switching element, the VoIP Migration Broker having a voice connection operative to receive instructions from a user on line configuration changes;
wherein the VoIP Migration Broker is operative to query at least one of the first switching element and the second switching element on line configuration information, receive the instructions on the line configuration changes, implement the line configuration changes on the line configuration information based on the instructions to obtain a modified line configuration and send the modified line configuration to the first and second switching elements.

2. The system as set forth in claim 1 wherein the first switching element is an analog switch.

3. The system as set forth in claim 2 wherein the analog switch is a Class 5 switch.

4. The system as set forth in claim 1 wherein the VoIP Migration Broker is operative to query the at least one of the first switching element and the second switching element by requesting a dump of text on the line configuration.

5. The system as set forth in claim 4 wherein the VoIP Migration Broker is operative to implement changes by running a Perl script on the text to replace values.

6. The system as set forth in claim 1 wherein the VoIP Migration Broker is operative to send a failure message if a request to the interface is not valid.

7. The system as set forth in claim 1 wherein the VoIP Migration Broker is operative to send a failure message if the changes are not successful.

8. The system as set forth in claim 1 wherein the information on the line configuration comprises information on line features and port assignments.

9. The system as set forth in claim 1 wherein the VoIP Migration Broker is operative to rollback migration of lines.

10. The system as set forth in claim 1 wherein the first phone system type is analog.

11. The system as set forth in claim 1 wherein the second phone system type is VoIP.

12. The system as set forth in claim 1 wherein the system further comprises a PBX unit.

13. A method for migrating lines in a telephone network from a first phone system type to a VoIP phone system type, the method comprising:
receiving a request to migrate lines to the VoIP phone system type through a voice connection;
validating the request;
querying at least one of a first switching element corresponding to the first phone system type and a second switching element corresponding to the VoIP phone system type to obtain line configuration data;
receiving a line configuration data;
modifying the line configuration data; and,
sending a modified line configuration to the first and second switching element.

14. The method as set forth in claim 13 further comprising sending a failure message if validating is not successful.

15. The method as set forth in claim 13 further comprising sending a failure message if the modifying is not successful.

16. The method as set forth in claim 13 further comprising sending a failure message if the confirming is not successful.

17. The method as set forth in claim 13 further comprising providing a software rollback of lines.

18. The method as set forth in claim 13 wherein the querying comprises requesting a dump of text to obtain text on the line configuration data.

19. The method as set forth in claim 18 wherein the modifying comprises modifying values in the text.

20. The method as set forth in claim 19 wherein the sending comprises sending the modified text having replaced values to the first and second switching elements.

21. The method as set forth in claim 13 further comprising modifying a line configuration in a PBX system.

22. The method as set forth in claim 21 further comprising sending a failure message if the modifying of the PBX system is not successful.
